(19) United States
(12) Patent Application Publication
(10) Pub. No.: US 2019/0217560 A1
(43) Pub. Date: Jul. 18, 2019

(54) UNDERWATER REPAIR METHOD AND SYSTEM

(71) Applicant: AquaBond LLC, Long Beach, CA (US)

(72) Inventor: Gary Weise, San Juan Capistrano, CA (US)

(21) Appl. No.: 16/250,731

(22) Filed: Jan. 17, 2019

Related U.S. Application Data
(60) Provisional application No. 62/618,378, filed on Jan. 17, 2018.

(51) Int. Cl. B29C 73/02; B29C 73/24

(52) U.S. Cl. CPC B29C 73/02; B29K 2075/00; B29C 73/24

(57) ABSTRACT

A method for underwater repair of a structure includes preparing a repair compound, applying the repair compound on a first side of a strip, placing the strip on an area requiring repair such that the first side of the strip faces the area requiring repair, and pressing on a second side of the strip opposite the first side to apply the repair compound to the area requiring repair. The method also includes distributing the repair compound over the area requiring repair while pushing water away from the area by pressing along the second side of the strip, and curing the repair compound.

### CROSS-REFERENCE TO RELATED APPLICATIONS

This application claims priority to co-pending U.S. Provisional Patent Application No. 62/618,378, filed Jan. 17, 2018, the entire content of which is incorporated herein by reference.

### FIELD OF THE INVENTION

Embodiments of the invention generally relate to the field of underwater repair of a structure, such as a pool, reservoirs, pipes, tanks, and other structures that can carry liquids.

### BACKGROUND OF THE INVENTION

Certain structures are designed to contain and carry liquids. These man-made structures include, for example, containers, reservoirs, pools, and pipes. These structures often have surfaces that are in contact with a liquid. When these surfaces are compromised, the structures can lose the ability to retain a liquid. Fractures, cracks, and holes are common types of problems that can lead to leaking of a liquid.

Present solutions for repairing a compromised area exist. For example, certain compounds may be applied to a compromised area to seal or fix fractures, cracks, and/or holes. Typically, repair compounds are placed within a fracture, crack, and hole. These repair compounds include, for example, polymers, resins, polyurethanes, cement, and the like. However, repair of these compromised structures or surfaces can present challenges. In order for repair compounds to be effective, liquid surrounding the repair site may need to be removed. It may be expensive or difficult to remove or replace a liquid in order to repair these structures or surfaces. Removal and replacement of the liquid can be labor intensive, and wasteful. For example, there may be economical and logistical challenges in removing water from a water reservoir in order to repair a compromised structure. Therefore, there is a need to repair a compromised structure while the structure is submerged in a liquid.

There are some repair compounds currently available that can be dispensed under a liquid. However, there are also challenges in applying such repair compound while the surface is submerged in a liquid. While attempting to seal or fix a surface under water there is difficulty in adhering these repair compounds to a substrate. If the repair compound has a lower density than the liquid, the repair compound may float away from the repair site. Additionally, there may be turbulence near the repair site. Turbulence can cause the repair compound to disengage from a repair site. For these reasons, and others, repair compound may not properly adhere to the surface that requires repair. Generally, these compounds can be sticky, and be difficult to work with. The repair compound may travel and stick to an unintended area, which could contaminate the liquid, and/or become caught in a person's hair, clothing, skin, eyes, etc. Excess compound may be needed to counteract this loss of material, potentially resulting in wasted materials. Using a repair compound while submerged may also result in a repair that is aesthetically displeasing. A repair compound may be difficult to handle while submerged, which can make it difficult to smoothen out or otherwise repair a surface while hiding the repair. Further, hydrostatic pressure may deform and/or push the repair compound out of its intended area before curing. Additionally, the repair compound may be exposed to the environment, which could be damaged before the compound is cured. For these reasons, multiple applications of a repair compound may be needed, leading to wasted time and resources.

In some cases, currently available solutions designed for use underwater, for example, underwater putties, provide inadequate tensile strength to repair a surface. These putties may display unsatisfactory adhesion to a surface. These putties may also be non-flexible. Due to the shortcomings of currently available underwater repair compounds, reapplication of these compounds may be required. Reapplication of these compounds may further require removing the liquid, which can be add to labor costs, and can be environmentally wasteful.

Therefore, there is a need for a method of repair that solves the problems described above. There is a need for a method of repair that allows repair of a surface while the surface is submerged in a liquid, while allowing proper repair of the compromised area. There is a need for a method of repair for of compromised structure that effectively seals the structure. There is a need for a method of repair of compromised structure while preserving the overall aesthetics of the structure. There is a need for a system that solves the problems described above, in order to repair an underwater structure.

### SUMMARY OF THE INVENTION

The invention provides, in one aspect, a method for underwater repair of a structure. The method includes preparing a repair compound, applying the repair compound on a first side of a strip, placing the strip on an area requiring repair such that the first side of the strip faces the area requiring repair, and pressing on a second side of the strip opposite the first side to apply the repair compound to the area requiring repair. The method also includes distributing the repair compound over the area requiring repair while pushing water away from the area by pressing along the second side of the strip, and curing the repair compound.

The invention provides, in another aspect, a method for underwater repair of a structure. The method includes preparing a repair compound, applying the repair compound on a first side of a strip, submerging the strip underwater to place the strip on an area requiring repair such that the first side of the strip faces the area requiring repair, curing the repair compound while the strip is submerged underwater, and after curing, removing the strip from the repair compound.

The invention provides, in another aspect, a system for underwater repair of a structure. The system includes a repair compound having an uncured state in which the repair compound is malleable and a cured state in which the repair compound is hardened. The repair compound is configured to transition from the uncured state to the cured state over a curing time. The system also includes a strip having a first side and a second side opposite the first side. The first side is configured to receive the repair compound in the uncured state and remain in contact with the repair compound over the curing time. The strip is removable from the repair compound in the cured state of the repair compound.

Certain embodiments of the invention describe methods and systems for repairing structures. In certain embodiments, a method of repairing structures under water is described. Other embodiments include a method for sealing a crack and leak underwater is described. Certain embodiments are directed to a method of applying a repair compound. In certain embodiments, a repair compound undergoes an exothermic reaction while curing. Other embodiments include placing a repair compound on a film or strip, and then placed over the crack. The film or strip can later be removed after curing. In certain embodiments, the repair compound effectively seals the compromised surface. Certain embodiments of the invention include a method to maintain the cosmetic quality of the repaired area.

Embodiments of the invention include a method for sealing and/or repairing surfaces. Surfaces for bonding include, but are not limited to acrylonitrile butadiene styrene (ABS), fiber-reinforced plastic (FRP), polyesters, styrenes, acrylics, gelcoats, plastics, metals such as aluminum, carbon steel, and stainless steel, urethanes, polymerizing vinyl chloride (PVC), vinyl esters, concrete, cement, phenolics, glass, wood, brick, stone, fiberglass, and tile. Certain embodiments of the invention include a method for sealing and/or repairing while submerged under a liquid, such as water.

Certain embodiments of the invention include an adhesive system for sealing and/or repairing surfaces. In certain embodiments, a flexible strip with a repair compound is applied to a surface. The repair compound can include a single material. In certain embodiments, a repair compound includes a plurality of materials. The plurality of components can be mixed prior to application. Embodiments include a repair compound having two-components mixed prior to application. In certain embodiments, a two-component compound includes, but is not limited to a two-part polyurethane system, a two-part methacrylate system, and a two-part polybutadiene system. Other embodiments include, a repair compound having a certain material that includes, but is not limited to polyester, isocyanate, polyol, epoxy, amine, silicone, and rubber.

In certain embodiments, a strip provides a surface for a repair compound. In certain embodiments, a strip includes a reusable material. In certain embodiments, a strip includes a recyclable material. In certain embodiments once a repair compound is cured on a repair site, the strip is removed. In certain embodiments, a strip acts to resist water from entering a repair site. In certain embodiments, a strip provides a surface that provides the repair compound a smooth surface once the compound is cured.

Materials or compounds commonly used to repair structures come in a variety of viscosities. Thinner compounds may generally be used for more temporary fixes, while thicker compounds may generally be used for more permanent fixes. In certain embodiments, the method and system described herein provide a strip that effectively repairs a structure while handling repair compounds having different viscosities.

In certain embodiments, the strip protects the repair area while a repair compound is curing. For example, the strip protects the repair area from local turbulence. While local turbulence can cause the repair compound to disengage from a surface, the steps of using a strip in certain embodiments prevents the repair compound from disengaging. In another example, the strip protects the repair area from damage before curing. In certain embodiments, the film is transparent, allowing a user to see where the repair compound is spread.

In certain embodiments, the method and system described allows easier repair. Instead of relying on an expert to handle structural repairs, certain embodiments of the invention allow repair of underwater structures to be handled by a lay person who is not necessarily an expert at structural repairs.

In certain embodiments, the method and system described can be used alongside other repair techniques. For example, in certain embodiments of the invention, the method for repairing a structure includes the device, system, and method as described in U.S. Provisional Patent Application No. 62/253,681 entitled “Post-Tensioning Apparatus and System for Structures,” filed Nov. 11, 2015, and U.S. patent application Ser. No. 15/349,790 entitled “Post-Tensioning Apparatus and System for Structures,” filed Nov. 11, 2016, both of which are incorporated herein by reference in their entireties.

Other features and aspects of the invention will become apparent by consideration of the following detailed description and accompanying drawings.

### BRIEF DESCRIPTION OF THE DRAWINGS

FIG. 1 is a flow diagram illustrating a method for repairing a surface in accordance with certain embodiments.

FIG. 2A illustrates an exemplary two-component repair compound.

FIG. 2B illustrates a strip and a repair compound, such as the repair compound of FIG. 2A.

FIG. 3 illustrates a compromised area repaired with the method of FIG. 1.

FIG. 4 further illustrates repair of the area of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Embodiments of the invention generally relate to the field of underwater repair of a structure. Embodiments of the invention include a method of underwater repair of a structure. Certain embodiments comprise a system for underwater repair of structure.

In general, repair areas that may benefit from the method and system described includes, for example, spider cracks, thin cracks, weeping cracks, divots, hollowing, egg-shelling, and delamination of certain surfaces. Furthermore, the method and system described is applicable for repair areas surrounding drains, returns, skimmers, jets, gutters, grates, tiles, light niches, steps, coping, expansion joints, and the like, as related to swimming pools, spas, and other structures.

Embodiments of the present invention include a repair compound comprising a single material. In certain embodiments, the repair compound comprises a plurality of materials. The plurality of components can be mixed prior to the application to a repair area. In certain embodiments, a repair compound includes two-components mixed prior to application to a repair area. In certain embodiments, a two-component compound includes, but is not limited to a two-part polyurethane system, a two-part methacrylate system, and a two-part polybutadiene system. The repair compound can include, but is not limited to polyester, isocyanate, polyol, epoxy, amine, silicone, acrylic, rubber, resins, and foams. Examples of two-component compounds include resin and curing agent combinations, isocyanate: polyol combinations, epoxy:amine combinations, and others. Examples of repair compounds include, for example, formulations provided by Aquabond, LLC (http://aquabondadhesives.com/, Long Beach, Calif.), which are incorporated by reference, although not limited to such formulations. Repair compounds can include those free of decabromodiphenyl ether. Repair compounds can also include moisture-insensitive compounds. Repair compounds can also include a two-component adhesive that when mixed together, undergoes an exothermic reaction during the curing process.

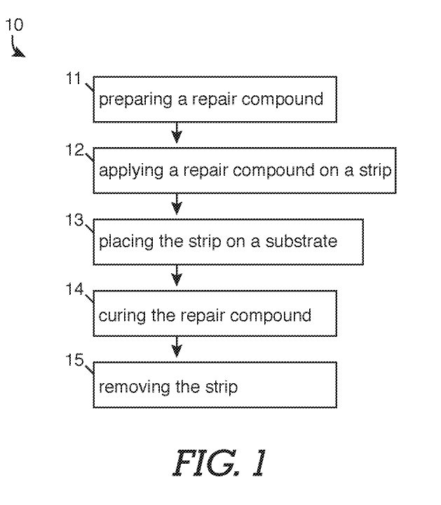

In certain embodiments of the invention, a method to seal and/or fix a repair area is described. The method comprises preparing a repair compound, applying the repair compound on a strip, placing the strip on a repair area, and allowing the repair compound to cure. FIG. 1 illustrates a flow diagram 10 with the steps for repairing a compromised area in certain embodiments of the present invention. Prior to repairing a structure, the repair site is identified. The size and shape of a repair site is evaluated. A strip that fits the general shape and size of the repair area, for example, a crack, may be selected. In order to choose an appropriately sized strip and appropriate amount of repair compound, in many cases, measuring and evaluating the repair area prior to repair is beneficial. The substrate located at or near the repair area may be cleaned. The repair area may be abraded, and/or brushed, as to remove organic and inorganic buildup, to increase bonding of a repair compound to the substrate.

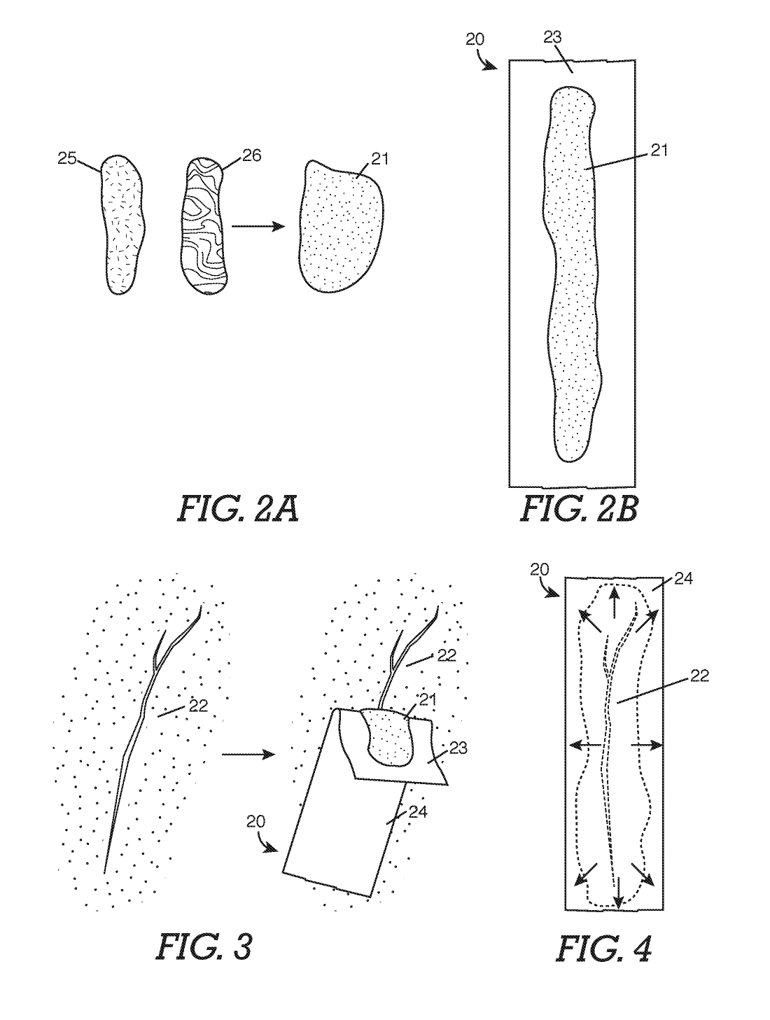

Referring to FIG. 1, in certain embodiments, the repair method includes preparing a repair compound (11). Preparing a repair compound includes the step of mixing of one or more constituent materials. For example, for two-component repair compounds, mixing of a first component 25 and a second component 26, as seen in FIG. 2A, is done in order to initiate a chemical reaction for curing and hardening. It will be appreciated that in certain embodiments, further mixing a plurality of components, such as a third component, a fourth component, and more, is necessary for certain repair compounds. The repair compound can be prepared outside of the liquid, for example, in air. In certain embodiments, a repair compound is prepared in the liquid.

Still referring to FIG. 1, the repair method includes applying a repair compound on a strip (12). A prepared repair compound 21 is applied on a strip 20 first side or surface 23, as exemplified in FIG. 2B. The strip can be transparent, translucent or opaque. In certain embodiments, a strip is non-stick, where the repair compound is releasable from the strip after curing. In other embodiments, the strip is reusable. The strip can include a polyethylene strip, although other materials are contemplated. Examples of other materials include, for example, polypropylene, and wax paper. In certain embodiments, the strip is provided in a rolled form. In certain embodiments, the strip includes a width between 2.54 cm (1 in.) and 12.7 cm (5 in.), although other sizes smaller and larger are contemplated.

Still referring to FIG. 1, in certain embodiments, the repair method includes placing the strip over a repair area (13). Referring to FIGS. 2-4, a repair area 22 may include, for example, a crack, although it will be appreciated that other types of features may be repaired. Referring to FIG. 3, a strip 20 with a repair compound 21 on a first surface 23 is placed on a repair area 22. In certain embodiments, a second side or surface 24 of the strip 20 is pressed. As seen in FIG. 4, the second surface 24 of the strip 20 may be pressed down. Pressing along the second surface 24 towards the edge of the strip 20 may spread and level the repair compound. It will be appreciated that spreading is accomplished using a spreader or fingers. In certain embodiments, the action of spreading is referred to as “feathering.” A spreader includes a tool that assists in spreading a repair compound. Examples of spreaders have a thin form, and straight and/or curved edges. It will be appreciated that spreading the repair compound away from a repair area provides a greater bonding surface for the repair compound.

In certain embodiments, the repair method 10 includes injecting a repair compound into the repair area, for example, within a crack, prior to placing the strip over a repair area (13). It will be appreciated that in certain embodiments, if the repair compound is injected into the repair area, the step (12) of applying a repair compound on a strip may be skipped. The use of the strip is beneficial in certain embodiments. The strip helps to cure the repair compound while decreasing the exposure of the repair compound to the liquid.

In certain embodiments, the strip distributes hydrostatic pressure of liquid surrounding the repair compound when the repair area is submerged. By acting as a barrier between the liquid and the repair compound, the strip may prevent the repair compound from being pushed through a crack in the repair area, for example. In some embodiments, the strip, under the influence of hydrostatic from the surrounding liquid, may create a seal to about ½ an inch on either side of a crack in the repair area. In some embodiments, the seal extend further than ½ an inch on either side of the crack.

Still referring to FIG. 1, in certain embodiments, the repair method includes curing the repair compound (14). Generally, the time for curing the repair compound depends on the type of repair compound used. In some embodiments, the time for curing the repair compound (i.e. to transition from an uncured state to a cured state) is at least 6 hours. In some embodiments, the time for curing the repair is between 12 hours and 24 hours. In certain embodiments, the strip may permit the repair compound to be smoothed and further worked in and around the repair area without compromising the repair compound. The strip prevents surrounding liquid from contacting at least an area of the repair compound during curing, which may improve and/or accelerate curing.

Once cured, the repair compound is generally hardened. After the recommended period of time to cure the repair compound, referring to FIG. 1, the strip is removed (15). Placing the strip on a repair area can further involve spreading the repair compound under the strip. The spreading allows the repair compound to be smoothed against the substrate. There are certain benefits for removal of a strip after the repair compound is cured. Using the strip, and removal of the strip allows the repaired area to have a more visually appealing quality compared to not using a strip.

In certain embodiments, a system for repairing a structure is provided. In certain embodiments of the invention, a system includes a repair compound, and a strip. In certain embodiments, a system includes a two-component repair compound and a strip. In certain embodiments of the invention, a system includes a two-component repair compound with an applicator (including, for example, a dispensing gun), and a strip. In certain embodiments, a system further includes a spreader.

Various features of the invention are set forth in the following claims. Although the invention has been described in detail with reference to certain preferred embodiments, variations and modifications exist within the scope and spirit of one or more independent aspects of the invention as described.

What is claimed is:

1. A method for underwater repair of a structure, comprising:
preparing a repair compound;
applying the repair compound on a first side of a strip;
placing the strip on an area requiring repair such that the first side of the strip faces the area requiring repair;
pressing on a second side of the strip opposite the first side to apply the repair compound to the area requiring repair;
distributing the repair compound over the area requiring repair while pushing water away from the area by pressing along the second side of the strip; and
curing the repair compound.

2. The method of claim 1, further comprising cleaning the area requiring repair prior to placing the strip.

3. The method of claim 1, wherein preparing the repair compound comprises mixing a first component with a second component of a two-component repair compound.

4. The method of claim 1, further comprising removing the strip after curing the repair compound.

5. The method of claim 4, wherein curing the repair compound occurs over a period between 12 hours and 24 hours.

6. The method of claim 1, wherein the strip is made of polyethylene.

7. The method of claim 1, wherein the strip is substantially transparent.

8. A method for underwater repair of a structure, comprising:
preparing a repair compound;
applying the repair compound on a first side of a strip;
submerging the strip underwater to place the strip on an area requiring repair such that the first side of the strip faces the area requiring repair;
curing the repair compound while the strip is submerged underwater; and
after curing, removing the strip from the repair compound.

9. The method of claim 8, wherein preparing the repair compound includes mixing a first component and a second component of a two-component polyurethane system.

10. The method of claim 8, further comprising, prior to curing, pressing on a second side of the strip opposite the first side to distribute the repair compound over the area requiring repair.

11. The method of claim 8, wherein curing the repair compound occurs over a period between 12 hours and 24 hours.

12. The method of claim 8, wherein the strip is substantially transparent

13. A system for underwater repair of a structure comprising:
a repair compound having an uncured state in which the repair compound is malleable and a cured state in which the repair compound is hardened, the repair compound configured to transition from the uncured state to the cured state over a curing time; and
a strip having a first side and a second side opposite the first side, the first side configured to receive the repair compound in the uncured state and remain in contact with the repair compound over the curing time,
wherein the strip is removable from the repair compound in the cured state of the repair compound.

14. The system of claim 13, wherein the repair compound includes a two-component polyurethane system.

15. The system of claim 13, wherein the curing time is between 12 hours and 24 hours.

16. The system of claim 13, wherein the strip is made of polyethylene.

17. The system of claim 13, wherein the strip is substantially transparent.

18. The system of claim 13, wherein the repair compound is configured to transition from the uncured state to the cured state while submerged in water.

19. The system of claim 18, wherein the strip is configured to separate an area of the repair compound from the water.

20. The system of claim 13, wherein the strip defines a width between 1 inch and 5 inches.
